(19) United States
(12) Patent Application Publication
(10) Pub. No.: US 2005/0166011 A1
(43) Pub. Date: Jul. 28, 2005

(54) System for consolidating disk storage space of grid computers into a single virtual disk drive

(76) Inventors: Robert J. Burnett, Dakota Dunes, SD (US); James L. Kroening, Dakota Dunes, SD (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/763,734

(22) Filed: Jan. 23, 2004

(51) Int. Cl. G06F 12/00

(52) U.S. Cl. 711/112; 711/170

(57) ABSTRACT

A system is disclosed for creating a virtual disk storage construct using disk storage consolidated from at least two grid computers of a computing grid. A method of the system includes locating an unused portion of a total disk storage space on disk drives of at least two grid computers of the computing grid, and presenting a portion of the total disk storage space of each of the at least two grid computers as a single virtual storage drive on at least one computer.

### BACKGROUND OF THE INVENTION

1. Field of the Invention

The present invention relates to grid computing systems and more particularly pertains to a system for consolidating available disk storage space of at least two grid computers and presenting the available disk storage space of the grid computers as a single virtual disk drive.

2. Description of the Prior Art

Grid computing, which is sometimes referred to as distributed processing computing, has been proposed and explored as a means for bringing together a large number of computers of wide ranging locations and often disparate types for the purpose of utilizing idle computer processor time and/or unused storage by those needing processing or storage beyond their capabilities. While the development of public networks such as the Internet has facilitated communication between a wide range of computers all over the world, grid computing aims to facilitate not only communication between computers but also to coordination of processing by the computers in a useful manner. Typically, jobs are submitted to a managing entity of the grid system, and the job is executed by one or more of the grid computers making up the computing grid.

However, while the concept of grid computing holds great promise, the execution of the concept has not been without its challenges. One challenge associated with grid computing is making use not only of the vast processing power available on the computing grid, but also the significant storage resources present on the computing grid.

The need for disk storage space, or storage space that is provided by fixed or hard disk drives, presents something of a paradox to the users or administrators of computing systems, and especially large scale enterprise network users. While enterprise computer systems often operate at the upper end of their disk storage capacity, private personal computer systems and even corporate personal computers systems typically utilize only a small fraction of their installed disk storage capacity. Paradoxically, the cost of disk storage space at an enterprise level is considerably more expensive than the cost of disk storage space at a personal computer level or even a network server level. A contributing factor to this cost differential is the redundancy often employed in corporate systems that is generally not utilized at the personal computer level. Those systems that do not employ some type of redundancy will often back up data to a different form of storage. And the challenge for the enterprise system administrator is not decreasing, as the typical enterprise system faces an ever-increasing amount of data that is created and needs to be stored. Thus, the disk storage needs of enterprise systems are unlikely to decrease or even level off in the foreseeable future.

In view of the foregoing, it is believed that there is a need for a system that can permit enterprise systems to take advantage of the relatively low cost, unused storage space that exists on many personal computers.

### SUMMARY OF THE INVENTION

In view of the large amount of unused disk storage space on smaller systems and the great need for unused disk storage space on larger systems, the present invention discloses a system for making available the unused disk storage available on many personal and corporate computers to enterprise systems which generally have the greatest need for such storage space.

In one aspect of the invention, a method is disclosed for creating a virtual disk storage construct using disk storage consolidated from at least two grid computers of a computing grid. The method includes locating an unused portion of a total disk storage space on disk drives of at least two grid computers of the computing grid and presenting a portion of the total disk storage space of each of the at least two grid computers as a single virtual storage drive on at least one computer.

In another aspect of the invention, the method of the invention is implemented by a program of instructions in a computer readable medium.

In one implementation of the invention, a portion of the total disk storage space on each of the grid computers may be allocated to be made available as part of the virtual storage drive.

In another implementation of the invention, a portion of the total disk storage space on each of the two grid computers may be reserved for local use.

In yet another implementation of the invention, at least one of the grid computers may be monitored for activity indicating that additional disk storage space has been added to the grid computer.

In still another implementation of the invention, at least one of the grid computers may be monitored for activity indicating that a minimum amount of free disk storage space has been violated.

In yet still another implementation of the invention, data from a reserved portion of the disk storage space of at least one of the grid computers may be copied to an available portion of at least two other grid computers of the computing grid that have been made available to the virtual storage drive to thereby backup the copied data from the reserved portion of the at least one grid computer.

A significant advantage of the invention is that the unused or surplus disk storage space of a large number of computers is brought together into a whole that is presented to users in a highly useable manner as a single storage drive similar to drives actually present ion the user's computer.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred implementations of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic diagram of a computing or storage grid system suitable for implementing the virtual disk storage system of the present invention to consolidate disk storage on a plurality of grid computers into a single disk drive construct.

FIG. 2 is a schematic diagram of a portion of a computing or storage grid showing the disk storage of each grid computer in an isolated manner to depict the concept of a virtual consolidation of disk storage space of the grid computers.

FIG. 3 is a schematic diagram of particular elements of a grid computer or node showing the conceptual interface between the disk storage on the computer and the agent application of the virtual disk storage system.

FIG. 4 is a schematic and highly conceptualized depiction of a disk storage device of a grid computer of the virtual disk storage system showing a breakdown of the portions of disk storage space on the disk drive.

FIG. 5 is a schematic flow diagram of one aspect of the initialization and storage space determination process of the virtual disk storage system of the present invention.

FIG. 6 is a schematic flow diagram of a process for monitoring changes in the disk storage space on a grid computer to determine if additional disk storage space has been added.

FIG. 7 is a schematic flow diagram of a process for monitoring changes in the disk storage space on a grid computer to determine if a minimum free disk storage space requirement has been violated and for restoring the minimum free space on the disk storage space if there has been a violation.

FIG. 8 is a schematic flow diagram of a process for backing up data from the local disk storage space of a grid computer to locations on the virtual disk storage system.

### DESCRIPTION OF PREFERRED EMBODIMENTS

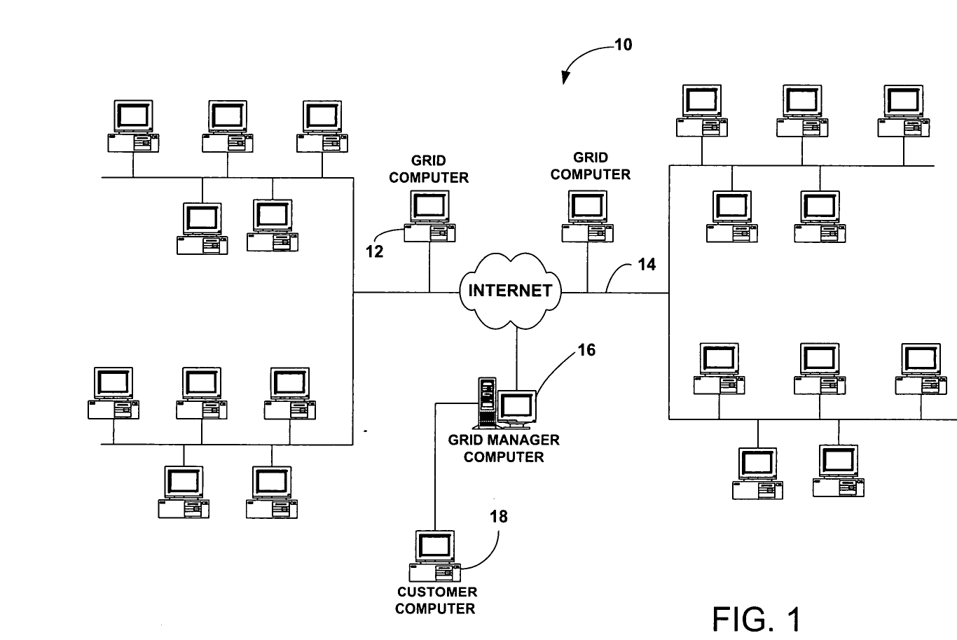

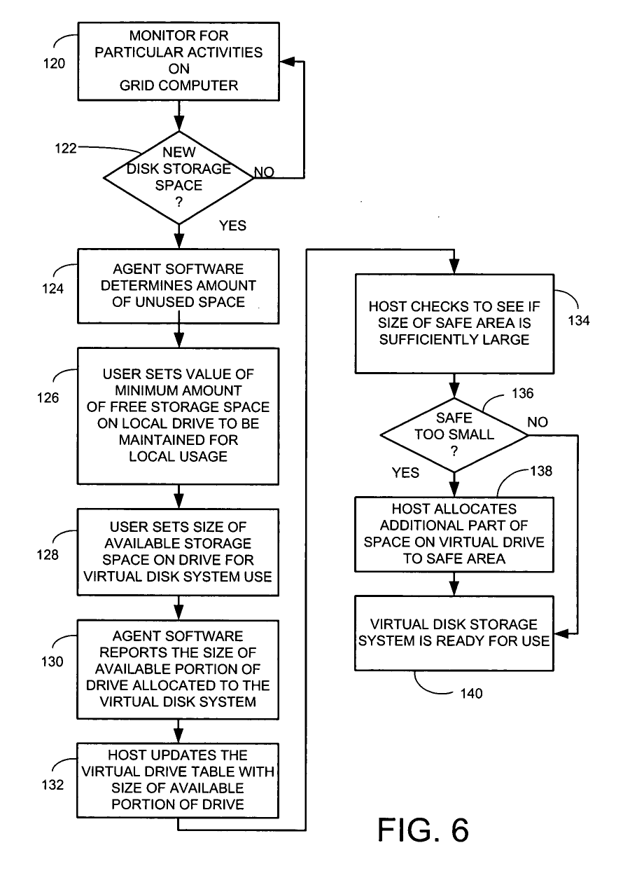

With reference now to the drawings, and in particular to FIGS. 1 through 8 thereof, a system for consolidating available disk storage space from at least two computers that embodies the principles and concepts of the present invention will be described.

The invention contemplates a method of and system for creating and maintaining an expedient or construct for virtual disk storage. The virtual disk storage construct comprises actual disk storage that is consolidated from the disk storage of a large number of computers but is made to appear as a single drive on the computers of each of the users of the construct. The virtual disk storage construct uses storage locations or space on the disk drives of at least two networked computers, and this disk storage is presented to a user of the virtual disk storage as a single consolidated storage device that appears to the user simply as an additional local hard disk drive on the user's computer and that may be accessed in a manner similar to the actual disk drive or drives of the user's computer. For the purposes of this description, disk storage space means locations on relatively permanent storage devices (or relatively permanent media) installed on a computer. While semi permanent or removable storage devices or media might also be used, the relatively unpredictable nature of their availability for access makes them less desirable for use in the invention.

While the invention may be implemented on a local area networks (LANs) and wide area networks (WANs), it is contemplated that aspects of the invention are highly suitable for employment on a computing grid that may include highly geographically dispersed networks of highly diverse computers operating over a larger scale network such as the Internet. The virtual disk storage construct may draw upon the disk storage of nodes or computers on a general or all purpose computing grid, or may draw upon the storage of nodes or computers of a special or single purpose computing grid established primarily for the purpose of consolidating storage.

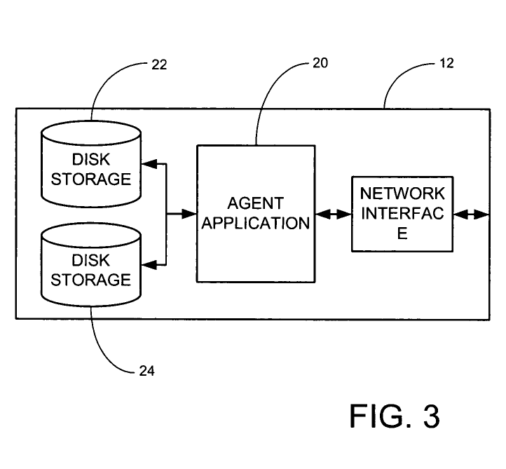

In an illustrative computing grid system 10 (see FIG. 1), a plurality of grid computers 12 linked or interconnected together for communication therebetween (such as by a linking network 14), with a grid host or manager computer 16 being designated to administer the grid system. Each of the grid computers 12 may be provided with a grid agent application 20 (see FIG. 3) being resident on the grid computer for communicating and interfacing with the grid manager 16 and administering local grid operations on the grid computer. In operation, a customer's computer 18 submits a job or storage task to the grid system 10, typically via the grid manager computer 16 which initially receives jobs for processing or data for storing by the grid system. The grid manager 16 accepts processing jobs or storage tasks from the customer computer 18, assigning and communicating the job to one of the grid computers 12, receiving results from the grid computer and communicating the final result back to the customer computer. The customer computer 18 may be one of the grid computers 12 on the grid system, or may be otherwise unrelated to the grid system 10.

In one embodiment of the invention, at least one of the grid computers 12 is located physically or geographically remote from at least one of the other grid computers, and in another embodiment, many or most of the grid computers are located physically or geographically remote from each other. The grid computers 12 and the grid manager computer 16 are linked in a manner suitable for permitting communication therebetween. The communication link between the computers may be a dedicated network, but also may be a public linking network 14 such as the Internet.

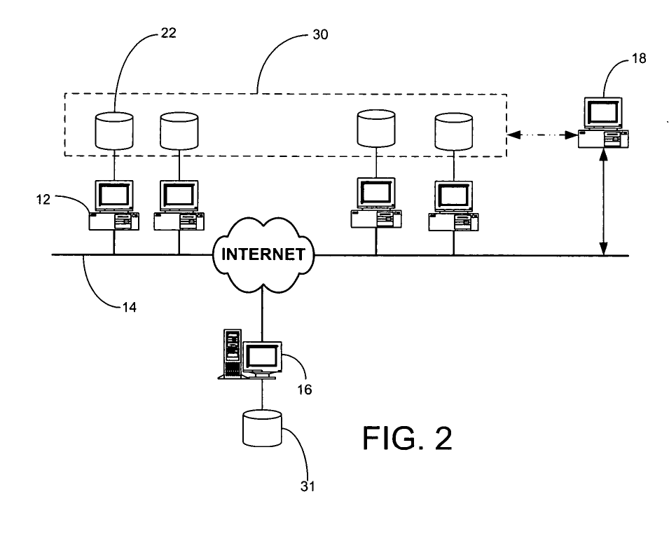

Each of the grid (FIG. 2) computers 12 typically has at least one hard disk storage drive 22 associated with it and usually incorporated into it, and each grid computer may also have one or more additional hard disk storage drives 24 (FIG. 3) also associated with it.

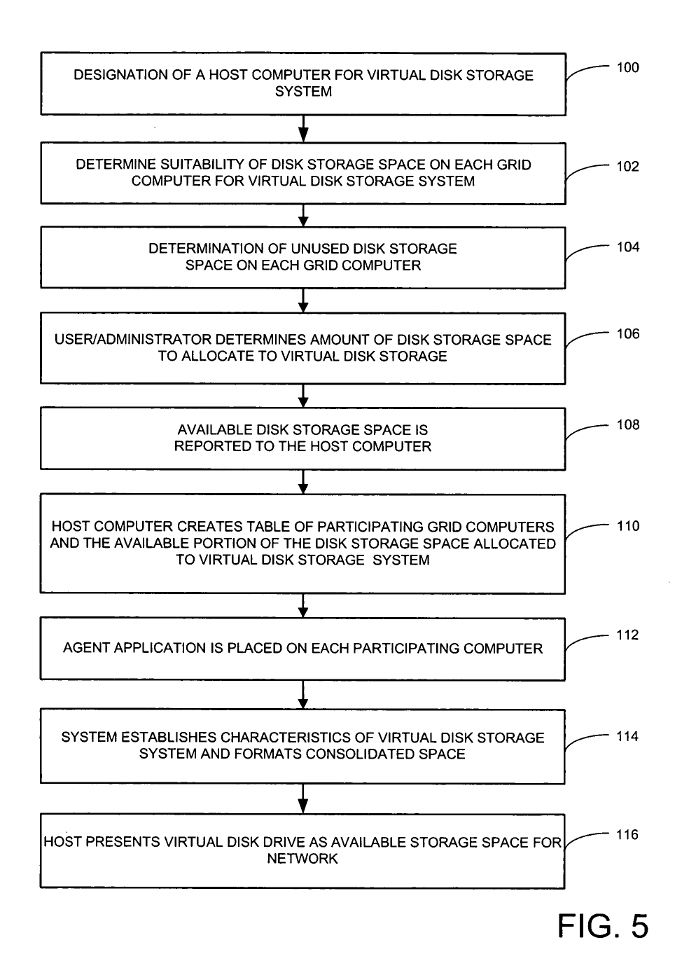

In one aspect of the invention, the virtual disk storage construct or system 30 may be established using disk storage contributed by the grid computers 12 of the computing grid 10. A computer on the computing grid may be designated to function as a host computer for handling management aspects of the virtual disk storage construct (block 100 in FIG. 5), and illustratively these functions are performed by the grid manager computer 16. The managing or host computer 16 may or may not be one of the computers contributing storage to the virtual disk storage system 30. As one of the management functions, the host computer may establish and maintain a table as part of a database 31 (see FIG. 2) that includes a listing of the grid computers contributing disk storage to the virtual disk storage 30 and the corresponding available disk storage 22, 24 available on each of the participating computers. The host computer 16 may also maintain addressing information for the locations of the participating computers 12 on the computing grid 10. The host computer may further handle data storage and retrieval operations including maintaining a listing of the encrypted addresses of the locations of specific data on the various grid computers 12 that has been transmitted to the virtual disk storage system for storage and then has been stored on one or more of the various grid computers.

One procedure that may be followed for determining the storage space available to the virtual disk storage system 30 on each of the participating grid computers 12 that may be contributing to the overall capacity of the virtual disk storage system is illustrate in FIG. 5. After the initial establishment of the virtual disk storage system, the process for determining available disk storage space may be performed on computers being added to the computing grid, as well as being repeated at various intervals on previously enrolled computers to update the available storage space status information on computers already a part of the virtual disk storage system. Optionally, the available storage space status information may be dynamically evaluated and updated on an individual computer basis in a manner that is described in greater detail below.

The procedure of determining the storage space available to the virtual disk storage system 30 may include requesting from each computer 12 of the computing grid 10 an indication of the amount of available storage space on the grid computer. This probing of the resources of each of the local grid computers 12 may be performed by a software application that is installed on the grid computer as part of an evaluation and initialization process in which the computer is evaluated for suitability and ability to participate in the virtual disk storage system. The application may be, for example, downloaded over a network such as the Internet to the grid computers 12, and may evaluate the suitability of the local grid computer based upon one or more factors (block 102 in FIG. 5). For example, criteria such as the relative size of the unused disk storage space and the predicted availability of the disk storage space for data storage and retrieval operations (including the character of the network connection) may be applied. Optionally, this evaluation process may occur as a part of the manufacturing process or initiation stage and then may occur at regular intervals or when certain activities occur on the local grid computer. The derived information may be reported to the host computer for evaluation of the suitability of the disk storage space of the particular grid computer.

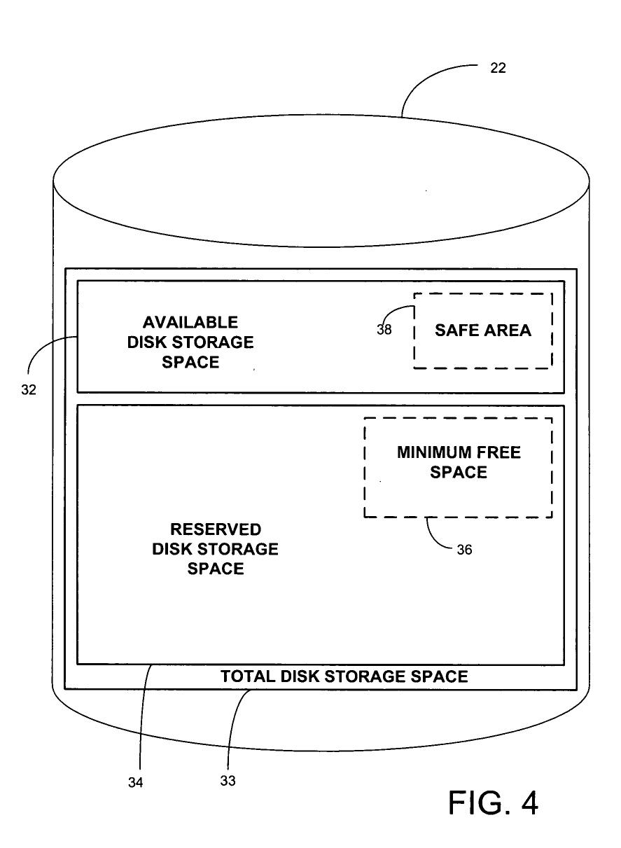

If the grid computer meets any suitability requirements that might be imposed, a determination may be made for each of the grid computers of the amount of total disk storage space 30 (see FIG. 4) available on the grid computer and the amount of unused storage space on the computer out of the total disk storage space 33 on the computer (block 104 in FIG. 5). The unused disk storage space is the portion of the total local disk storage space that is not currently being used for storing data for local applications or for other local purposes.

A portion of the total disk storage space 30 that is used for local purposes may be allocated to the virtual disk storage system as available storage space 32 (see FIG. 4). The available disk storage space 32 of a grid computer is the portion of local disk storage space allocated for and offered to the virtual disk storage system for data storage purposes. The balance of the total disk storage space may be reserved disk storage space 34 that is reserved or saved for use by local applications or local purposes of the user and is not available for use by the virtual disk storage system. Optionally, the local user of the computer contributing the disk storage space may be allowed to determine or set the amount (or percentage) of the local total disk storage space 33 to reserve for local purposes, and the available disk storage space is the balance between the reserved amount and the total amount. The amount of the reserved storage space 34 generally should exceed by a margin the portion of the disk storage space currently actually being used for local purposes to provide for reasonable future expansion of the local storage needs. Conversely, the disk storage space made available to the virtual disk storage system should be less than the unused disk storage space. The user may also determine a minimum amount of free disk storage space 36 to be maintained on the reserved portion of the disk storage space at all times. A process for administering this aspect of the invention is described below.

The amount of available local disk storage space may be reported to the host computer or other managing entity of the virtual disk storage system, along with any other information about the local grid computer that may be considered useful (block 108 in FIG. 5) and the available disk storage space 32 is recorded in the table (block 110).

The host computer or other entity administering the virtual disk storage system may create the database table 31 or other data structure listing the contributing grid computers and the corresponding available storage space on each of those contributing grid computers (block 110). The host computer may also maintain the table by updating the table as grid computers are added to or removed from the virtual disk storage system, or as the available storage space increases or decreases.

Once the suitability of the disk storage space of the local grid computer for the purposes of the virtual disk storage system has been established, an agent software application 20 may be loaded on each of the participating grid computers to act as the local manager of the data moving onto and being retrieved from the one or more hard disk drives that comprise the local disk storage space (block 112). Optionally, the application initially downloaded to the grid computer for the purpose of determining suitability and available disk storage space on the computer may also provide these functions.

The agent application may also be enabled to operate as a local presence of the virtual disk storage system for handling any requests originating from local applications on the local grid computer for storing data on the virtual disk storage system. This operation may include generating a presence on the local computer that is recognized by the local computer as a storage drive so that the presentation of the virtual disk storage system to the computer user on the local computer is as similar as possible to other drives that are actually present on the grid computer.

An administrative entity of the virtual disk storage system may, through the host computer, establish a number of the characteristics of the virtual disk storage system (block 114). One characteristic may be the overall capacity of the virtual disk storage system based upon the capacities made available by the participating computers. Another characteristic may be a format for data storage on the virtual disk storage system. A further characteristic may be the appropriate levels of security to be employed in transmissions between the administering host computer and the participating computers, and the level or levels of security to be applied locally to the data maintained on the grid computer to prevent access to the data of the virtual disk storage system by the local user of the grid computer. Another characteristic that may be established is the level of reliability expected from the virtual disk storage system, including the aspects of redundancy and error correction applied to the data that is stored on the virtual disk storage system. These characteristics can make the data stored more secure and more reliable than on the user's own computer. The consolidated disk storage space may then be presented by the host computer through the agent application 20 to users as a single drive (block 116).

In another aspect of the invention, the activity on one or more of the participating grid computers may be monitored for indications that disk storage space conditions may have changed. These conditions may include a change in the total disk storage space or the unused disk storage space on the grid computer.

This aspect of the invention may be implemented locally at least in part by the agent application 20 of the virtual disk storage system that is resident on the grid computer after the grid computer has been enrolled on the system. The agent application may operate in the background on the grid computer to monitor the factors or activities occurring on the computer for those that generally correspond to situations where the total hard drive storage space has increased or decreased, such as the addition of another hard drive. Optionally, the agent application may monitor the grid computer for factors that indicate that the amount of hard drive storage space actually being used for local purposes has decreased to a degree that additional disk storage space might be allocated to the virtual disk storage system. Upon detection of one or more of the factors or activities that indicate that additional disk storage space might be available for allocation to the virtual disk storage system, a process may be executed that is similar in some respects to the process of initializing the participation of the local grid computer on the virtual disk storage system.

The agent application, operating in the background on the grid computer as a part of normal virtual disk storage system operations for storing data on and retrieving data from the disk storage space, may also monitor local conditions on the computer for conditions that indicate that a new hard drive has been added to the grid computer (block 120). These factors or activities may include, for example, detection of a rebooting of the operating system of the grid computer, detection of a change in drive status by polling the drives, the completion of a write operation to the disk storage, or recognition by the operating system of a new storage device. Further, the activities may be relatively unconnected to activities on the disk storage, such as, for example, the passage of a predetermined amount of time since a previous checking of the disk storage space, or the arrival of a specific time or date. A change in one of these conditions may also indicate the removal of a hard disk drive from the system, which would likely necessitate a change (or at least a reevaluation of) the amount of disk storage space reserved for local use and allocated to the virtual disk storage system.

Optionally, the agent application may also monitor conditions that indicate that the amount of disk storage space reserved for local use may be too small or too large. For example, the agent application may monitor the amount of the disk storage space that is being used by local applications.

Upon detecting the occurrence of one or more of these activities or conditions, the agent application 20 may initiate a process of reevaluation of the total and unused disk storage space. The agent application 20 may seek to determine if additional disk storage has been added (block 122). This process may be initiated automatically by the agent application, or the agent application may prompt the user of the grid computer to consider initiating the process if reallocation of disk storage space might be considered by the user. In either case, the agent application may determine and then inform the user of the total disk storage space 33 currently on the grid computer (block 124), the present amount of reserved disk storage space 34, the present allocation of disk storage space 32 available to the virtual disk storage system, and possibly the conditions or factors that caused the agent application to indicate that a reallocation of these amounts might be considered desirable. The agent application may indicate to the user what percentage of the reserved portion of the disk storage space remains unused, especially if the triggering condition for the reevaluation is that only a small percentage of the reserved portion of disk storage space is presently being utilized. The user may also set a minimum amount of free disk storage space 36 to be maintained in the reserved portion of the disk storage space (block 126). The user may at this time reallocate the total disk storage space between the reserved and available portions of the total disk storage space (block 128). It will be appreciated that the new reserved amount of the disk storage space should not be less than the amount of disk storage space currently being used for local purposes, and similarly the new amount of disk storage space made available to the virtual disk storage system should not be less than the amount of data presently being maintained by the virtual disk storage system on the disk storage space, at least without notifying the host computer of the virtual disk storage system prior to the reallocation so that some of the stored data may be transferred.

If the user authorizes the reallocation of the disk storage space between the reserved and available portions, then the agent application notifies or reports to the host computer that the reallocation has occurred (block 130), and the host computer updates the table to reflect the increased or decreased amount of available disk storage space on the particular host computer (block 132).

In some implementations of the invention, a safe storage area 30 may be maintained as part of the virtual disk storage system that is generally kept free of data for use in managing the data stored on the virtual disk storage system, such as for temporary data storage when data needs to be moved from one location to another location within the virtual disk storage. The size of the safe area or portion of the virtual disk storage system may be monitored so that it is maintained with a minimum size, or within a predetermined range of sizes based upon the actual virtual disk storage system capacity. The safe area may be located on a plurality of computers contributing available disk storage space.

The addition of more available disk storage space to the virtual disk storage system may require a reevaluation of whether the safe area of the virtual disk storage is sufficiently large, and conversely the removal of storage space from the virtual disk storage may require an evaluation of whether the size of the safe area is larger than needed in order to maintain the desired minimum size (block 134). If the reevaluation of the size of the safe area with respect to the overall size of the virtual disk storage system is not within a predetermined acceptable range (block 136), then portions of the virtual disk storage may be reallocated into or out of the safe area (block 138). This reallocation may require, for example, that a portion of the disk storage space on the grid computer may have to be moved into or out of the designated safe area of the virtual disk storage system. The virtual disk storage system is then ready for further storage operations (block 140).

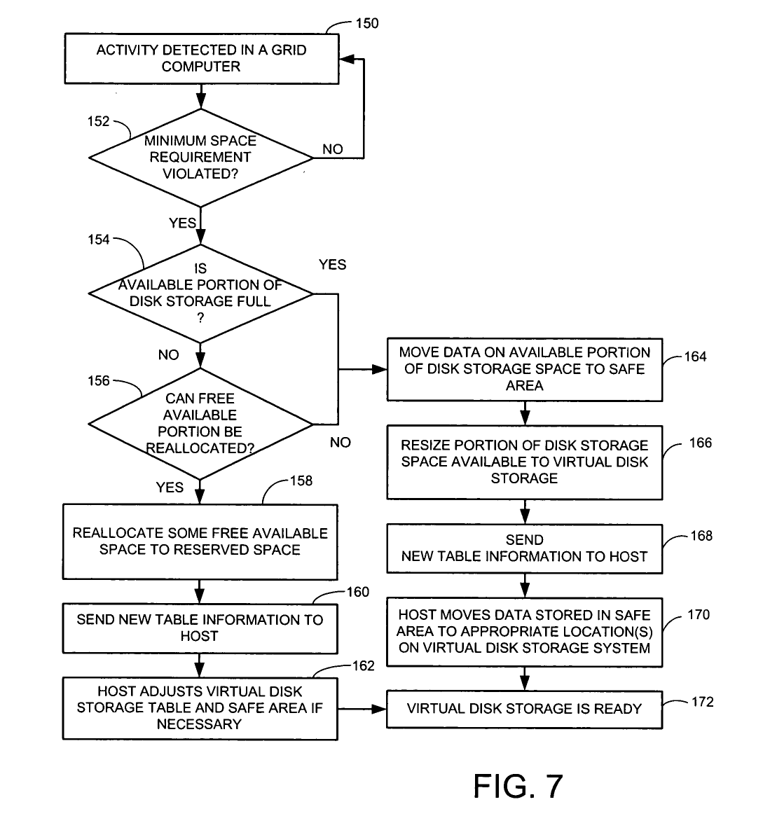

In another aspect of the invention, the disk storage space on the local grid computer may be monitored to detect if a predetermined minimum amount of free or unused disk storage space 36 is violated so that less than the predetermined minimum amount is free (see FIG. 7). The minimum amount of free storage space may be a condition that is applied to the reserved portion of the disk storage space only, so that any free storage space on the portion of the disk storage space available to the virtual disk storage system is not considered a part of the free storage space in making this determination. The minimum free space may be monitored on all of the disk storage space on the local grid computer, including multiple hard disk drives on the computer.

The activity on the local grid computer may be monitored by the local agent application of the virtual disk storage system (block 150), and when particular types of activity are detected, the amount of free space on the disk storage space may be checked against the predetermined minimum amount that has been established (block 152). The types of activity that trigger the agent to check the amount of free space may be the same as or similar to the types or kinds of activities as those activities listed above.

If a violation of the minimum free space requirement of disk storage space is detected on the local grid computer, a process may be initiated that attempts to restore the minimum free storage space on the reserved portion of the disk storage space. The process includes determining if the available portion of the disk storage space allocated to the virtual disk storage system is full, or fully occupied by stored data (block 154). If the available portion of disk storage space is not fully occupied by stored data, the local agent application determines if a part of the available portion can be reallocated to the reserved portion of the disk storage space so that the minimum free space amount may be restored on reserved portion (block 156). If the available portion of the disk storage space can be reallocated for local use as a part of the reserved portion, then the agent application of the virtual disk storage system allocates a part of the available portion of the disk storage space to the reserved portion (block 158). This step may be accomplished without having to move data stored on the local disk storage space to another location on the virtual disk storage system. The amount of disk storage space reallocated to the reserved portion should be sufficient to restore the minimum free space requirement on the reserved portion of the disk storage space. The agent application then informs the host computer of the virtual disk storage system of the reallocation and the new amount of the local disk storage space that is being made available to the virtual disk storage system (block 160). The host computer updates the table of available storage space corresponding to the particular grid computers on which the reallocation has occurred (block 162).

If the disk storage space on the local grid computer that is available to the virtual disk storage system is full (block 154), or if the free or unused space of the available disk storage space cannot be reallocated to the reserved portion of the local disk storage space, a part of the data stored on the available disk storage space is moved to the safe storage allocation of the virtual disk storage system (block 164). The available disk storage space and the reserved disk storage space is then resized by the agent application (block 166), which typically includes decreasing the size of the portion of the disk storage space allocated to the virtual disk storage system and increasing the size of the reserved disk storage space. The size of the reallocated disk storage space available to the virtual disk storage system is reported by the agent application to the host computer (block 168), and the table is revised to reflect the resized available portion of the disk storage space of the local grid computer. The displaced data temporarily stored in the safe storage area 30 may be moved to the available disk storage space on at least one other grid computer of the virtual disk storage system (block 170) and the virtual disk storage system is ready for further use (block 172).

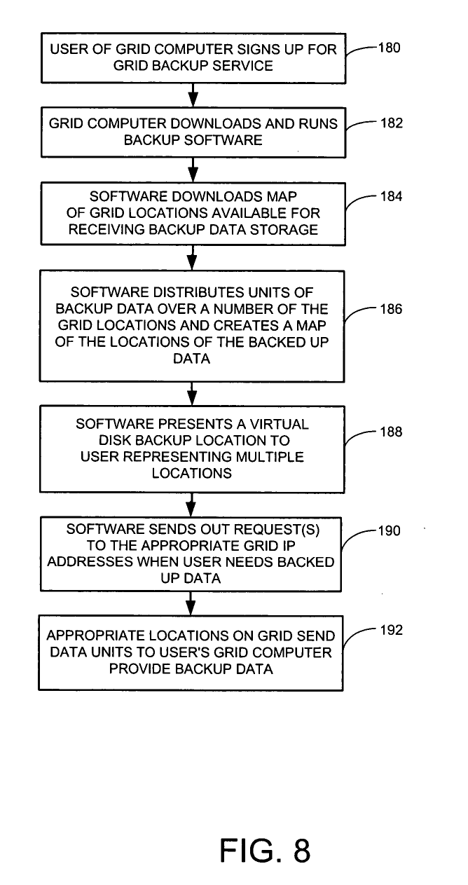

In another aspect of the invention, the virtual disk storage system as implemented may perform a backup or provide a type of redundancy of data that is stored on the reserved portion of the disk storage space of the local grid computers by local applications for local purposes (see FIG. 8). The virtual disk storage system, acting through the agent application 20, may periodically or at the initiation of the local user take the data that is stored on the reserved portion of the disk storage space and store that information on the disk storage space of other participating grid computers of the virtual disk storage system to thereby backup the data stored on the reserved portion of the disk storage space in case the data needs to be recovered.

In one implementation of the invention, the user of the grid computer may sign up or register for the backup service (block 180), and an appropriate software application may be downloaded or otherwise loaded onto the grid computer (if not already present on the user's computer). The software application may contain a map of locations on the grid or on the virtual disk storage system available for receiving backup data from the disk storage of the grid computer (block 184). At the time of each backup event, the data on the reserved portion of the disk storage space of the grid computer may be broken up into a plurality of slices or units (block 186), and each of the units of data may be stored on the disk storage space of a different grid computer at the locations on the map so that the entirety of the backed up data is not saved on the disk storage space in a single location or on a single grid computer. The backed up data may be presented to the user of the computer as a single disk drive (block 188), or a single location on the grid computer. The backup software application may send out requests to the locations for recalling the data from the locations if needed (block 190), and the locations will return the units of data that they posses so that the software application may reassemble the units into the requested lost data (block 192).

The breakup of the data into smaller units makes the data more secure in that a unit of data stored on a grid computer may have a significantly diminished meaning to those who might gain unauthorized access to the unit of data. The data backup operation may be conducted at times of off peak network or virtual disk storage system usage, or may occur upon the occurrence of specified activities, such as the close of a file or files on the user's grid computer.

The host computer may also maintain a listing of the locations of the slices or units of the data that is backed up on the virtual disk storage system for each of the users having data backed up. Optionally, the agent application may send the units of data directly to the locations on the virtual disk storage system when data backup is needed, rather than directing the data through the host computer or other managing entity of the virtual disk storage system.

The foregoing is considered as illustrative only of the principles of the invention. Further, since numerous modifications and changes will readily occur to those skilled in the art in view of the disclosure of this application, it is not desired to limit the invention to the exact embodiments, implementations, and operations shown and described. Accordingly, all equivalent relationships to those illustrated in the drawings and described in the specification, including all suitable modifications, are intended to be encompassed by the present invention that fall within the scope of the invention.

1. A method of creating a virtual disk storage construct using disk storage consolidated from at least two grid computers of a computing grid, comprising:
locating an unused portion of a total disk storage space on disk drives of at least two grid computers of the computing grid; and
presenting a portion of the total disk storage space of each of the at least two grid computers as a single virtual storage drive on at least one computer.

2. The method of claim 1 additionally including allocating a portion of the total disk storage space on each of the at least two grid computers to be made available as part of the virtual storage drive.

3. The method of claim 2 additionally including reserving a portion of the total disk storage space on each of the at least two grid computers for local use.

4. The method of claim 1 additionally including determining the total disk storage space on each of the at least two grid computers and allocating the total disk storage space between a portion made available for use as part of the virtual storage drive and a portion reserved for local use on the grid computer.

5. The method of claim 1 additionally including maintaining a table of grid computers contributing storage space to the virtual storage drive and corresponding amounts of storage space made available by each contributing grid computers.

6. The method of claim 1 additionally including monitoring at least one of the grid computers for activity indicating that additional disk storage space has been added to the at least one grid computer.

7. The method of claim 6 additionally including allocating disk storage space on the at least one grid computer after detecting activity indicating that additional storage space has been added to the at least one grid computer.

8. The method of claim 1 additionally including monitoring at least one of the grid computers for activity indicating that a minimum amount of free disk storage space has been violated.

9. The method of claim 8 additionally including allocating disk storage space on the at least one grid computer after detecting activity indicating that the minimum amount of free disk storage space has been violated to restore at least the minimum amount of free disk storage space.

10. The method of claim 1 additionally including providing a safe area on disk storage space of the virtual storage drive, the safe area being kept free of data.

11. The method of claim 1 additionally including loading an agent application on each of the grid computers for managing disk storage space on the grid computer made available to the virtual storage drive.

12. The method of claim 4 additionally comprising copying data from a reserved portion of the disk storage space of at least one of the grid computers to an available portion of at least two other grid computers of the computing grid that have been made available to the virtual storage drive to thereby backup the copied data from the reserved portion of the at least one grid computer.

13. A computer readable medium tangibly embodying a program of instructions implementing the following method of creating a virtual disk storage construct using disk storage consolidated from at least two grid computers of a computing grid:
locating an unused portion of a total disk storage space on disk drives of at least two grid computers of the computing grid; and
presenting a portion of the total disk storage space of each of the at least two grid computers as a single virtual storage drive on at least one computer.

14. The computer readable medium of claim 13 additionally implementing the step of allocating a portion of the total disk storage space on each of the at least two grid computers to be made available as part of the virtual storage drive.

15. The computer readable medium of claim 14 additionally implementing the step of reserving a portion of the total disk storage space on each of the at least two grid computers for local use.

16. The computer readable medium of claim 13 additionally implementing the step of monitoring at least one of the grid computers for activity indicating that additional disk storage space has been added to the at least one grid computer.

17. The computer readable medium of claim 13 additionally implementing the step of monitoring at least one of the grid computers for activity indicating that a minimum amount of free disk storage space has been violated.

18. The computer readable medium of claim 13 additionally implementing the step of providing a safe area on disk storage space of the virtual storage drive, the safe area being kept free of data.

19. The computer readable medium of claim 15 additionally implementing the step of copying data from a reserved portion of the disk storage space of at least one of the grid computers to an available portion of at least two other grid computers of the computing grid that have been made available to the virtual storage drive to thereby backup the copied data from the reserved portion of the at least one grid computer.
